(19) United States
(12) Patent Application Publication
(10) Pub. No.: US 2010/0223382 A1
(43) Pub. Date: Sep. 2, 2010

(54) EMBEDDED COLLECTION AND INVENTORY SYSTEM AND METHOD FOR FACILITATING NETWORK SUPPORT FOR AN INSTALL-BASE NETWORK

(75) Inventors: Ammar Rayes, San Ramon, CA (US); Michael Cheung, North York (CA); James McDonnell, Pleasanton, CA (US)

Correspondence Address: EDELL, SHAPIRO & FINNAN, LLC, 1901 RESEARCH BOULEVARD, SUITE 400, ROCKVILLE, MD, 20850, US

(73) Assignee: Cisco Technology, San Jose, CA (US)

(21) Appl. No.: 12/395,221

(22) Filed: Feb. 27, 2009

(51) Int. Cl. G06F 15/173

(52) U.S. Cl. 709/225

(57) ABSTRACT

A system, method and application for facilitating network support for an install-base network is provided. The method includes performing, at an access node of the install-base network, network discovery to discover one or more nodes of the install-base network. The method also includes collecting, at the nodes, their respective inventories (“network-node inventories”). The method further includes collecting the network-node inventories at the access node, and sending the network-node inventories from the access node to a back-office system external to the install-base network. The method may, optionally, include the access node aggregating the network-node inventories to form aggregate information, and sending the aggregate information to the back-office system in addition to or in lieu of the of network-node inventories.

### BACKGROUND

1. Field

The following generally relates to computer networks, and more particularly, to an embedded collection and inventory system and method for facilitating network support for an install-base network.

2. Related Art

As is commonly known, a business can deploy and use its computer network to exchange information among its constituents, and via interconnection with an external computer network, exchange information between its constituents and other persons not employed by the business and/or external to the business' computer network. In addition, the business' computer network provides a platform by which a service provider can market and/or serve its services to the business.

To facilitate the foregoing, the business' computer network includes a number of interconnectable network elements or “network nodes”. Each of the network nodes may embody and/or function as any of switch, router, gateway and like-type network device (collectively “network device”). And in general, each of the network nodes includes a processor-based platform that operates on any suitable network operating system, such as Cisco® Internetwork Operating System (“IOS”), and that is capable of executing software.

Although many of the network nodes are configured and/or function as the same type of network device, each network node is unique in that it defines one or more attributes (“network-node attributes”) that are assigned to and/or otherwise associated with such network node. These network-node attributes may include, for example, any of a serial number, product identification code, hostname, hardware information, software information and the like.

Suppliers of, architects of and/or information-technology departments associated with the business' computer networks often maintain a database (“deployment database”) that includes some or the entire network-node attributes of each of the network nodes as shipped and/or initially installed (“factory/default-network-node attributes”). Often times, the factory/default-network-node attributes from deployment database are used to facilitate support for the business' computer network. And as can be imagined, the factory/default-network-node attributes may be different from the network-node attributes currently in use by the network nodes of the business' computer network. This, in turn, causes problems with supporting or, worse yet, an inability to carry out support of the business' computer network, including, for example, performing any of network assessment; diagnostics and remediation; configuration management; provisioning management; reporting and other like-type functions.

To combat this issue in the past, the suppliers, architects and/or information-technology departments manually collect an inventory of each of the network nodes. Such collection is carried out by a network administrator, who visually inspects each network node and record (in hardcopy or electronic form) the network-node attributes written on the outside of such nodes and/or uses an administrator computer to directly or indirectly log into each network node (e.g., via a command-line interface) and record the network-node attributes in hardcopy or electronic form. Thereafter, the network administrator uploads or otherwise populates the deployment database with the recorded network-node attributes.

In other conventional approaches, the suppliers, architects and/or information-technology departments have automated the manual collection of the inventories of the network nodes be essentially replacing the network administrator with a dedicated network appliance that directly or indirectly log into each of network nodes and records the network-node attributes in electronic form. Thereafter, the network administrator and/or network appliance uploads or otherwise populates the deployment database with the recorded network-node attributes.

These conventional approaches prove to be expensive in deployment and maintenance, particularly, for small and medium sized businesses. Beyond the cost and maintenance of an additional dedicated and non-value added network device, the conventional approaches that utilize such dedicated network appliance suffer from being a single point of failure; making such conventional approaches undesirable.

Therefore, there is a need in the art for an efficient and cost effective collection and inventory system and method for facilitating network support.

### BRIEF DESCRIPTION OF THE DRAWINGS

So the manner in which the above recited features are attained and can be understood in detail, a more detailed description is described below with reference to Figures illustrated in the appended drawings.

The Figures in the appended drawings, like the detailed description, are examples. As such, the Figures and the detailed description are not to be considered limiting, and other equally effective examples are possible and likely. Furthermore, like reference numerals in the Figures indicate like elements, and wherein:

FIG. 1 is a block diagram illustrating example network architecture for facilitating network support for an install-base network;

FIG. 2 is a block diagram illustrating an example network node of an install-base network;

FIG. 3 is a block diagram illustrating an example access node of an install-base network;

FIG. 4 is a block diagram illustrating an example of a back-office system for facilitating network support for an install-base network;

FIG. 5 is a block diagram illustrating an example administrator node for facilitating network support for an install-base network;

FIG. 6 is a flow diagram illustrating a first example flow for facilitating network support for an install-base network;

FIG. 7 is a flow diagram illustrating a second example flow for facilitating network support for an install-base network;

FIG. 8 is a flow diagram illustrating a third example flow for facilitating network support for an install-base network; and

FIG. 9 is a flow diagram illustrating a fourth example flow for facilitating network support for an install-base network.

### DETAILED DESCRIPTION

### Overview

Embodiments of the invention include a system, method and application for facilitating network support for an install-base (“IB”) network. The system includes one or more network nodes and an access node of the install-base network. The network nodes are configured to collect their inventories (“network-node inventories”), and the access node is configured to (i) perform network discovery to discover at least one network node, (ii) collect the inventory of the at least one network node, (iii) collect inventory at the access node; (iv) send the inventory to a back-office system external to the network containing the at least one node. The access node may also be configured to (i) aggregate the network-node inventories to form aggregate information, and (ii) send the aggregate information to the back-office system in addition to or in lieu of the of network-node inventories.

In the following detailed description, numerous specific details are set forth in order to provide a thorough understanding of exemplary embodiments or other examples described herein. However, it will be understood that these embodiments and examples may be practiced without the specific details. In other instances, well-known methods, procedures, components and circuits have not been described in detail, so as not to obscure the following description. Further, the embodiments and/or examples disclosed are for exemplary purposes only and other embodiments and/or examples may be employed in lieu of or in combination with the embodiments disclosed.

### Example Network Architecture

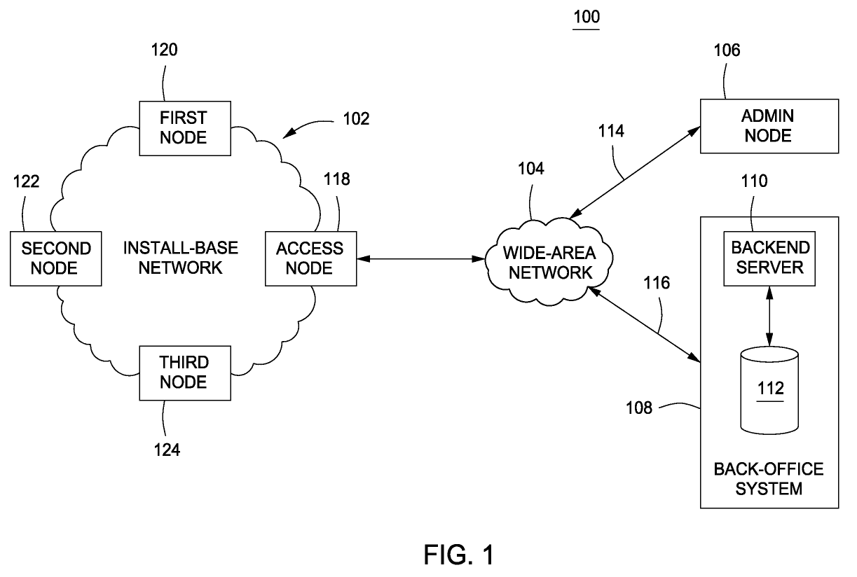

FIG. 1 is a block diagram illustrating example network architecture 100 for facilitating network support for an install-base network, such as install-base (“IB”) network 102. In addition to the IB network 102, the network architecture 100 includes a wide-area network (“WAN”) 104, an administrator node 106 and a back-office system 108, which in turn, includes a backend server 110 and an IB database 112.

To facilitate communication to, from and/or among the administrator node 106 and back-office system 108, each of the administrator node 106 and back-office system 108 may communicatively couple to the WAN 104 via first and second communication links 114, 116. Alternatively and/or additionally, each of the administrator node 106 and back-office system 108 may communicatively couple to one another via other communication links (not shown) that do not utilize the WAN 104.

The WAN 104 may be, for example, a public network, a non-publicly accessible (“private”) network and/or some combination thereof. As the public network or part thereof, the WAN 104 may be a partial or full deployment of most any telecommunication network, computer network or convergence thereof to which any interested member of the public can be provided with (e.g., served) communication services, including, for example, services for exchanging datagrams or packets. As such, the WAN 104 may be or include any part of a public, terrestrial wireless, and/or wireline telecommunications and/or computer network. The WAN 104 may, for example, include all or portions of the Internet, proprietary public networks, other public wired and/or wireless packet networks, etc.

As the private network or part thereof, the WAN 104 may be a partial or full deployment of most any telecommunication network, computer network or convergence thereof for serving the communication services to certain select groups, and not to the general public. Examples of the private network include an enterprise, military or service-provider managed WAN. The WAN 104 may also be or include any part of a Virtual Private Network (“VPN”) or any other partitioning of the public and/or private network.

Although the WAN 104 is shown as being contiguous, it may be a plurality of mutually exclusive networks, including, for example, autonomous systems and/or networks. In general, the WAN 104 provides, for entities that can connect to it, the ability to exchange communications with any of the administrator node 106, back-office system 108 and other network nodes (not shown) communicatively coupled thereto.

The IB network 102, like the WAN 104, may be a public network, a non-publicly accessible (“private”) network and/or some combination thereof. As the public network or part thereof, the IB network 102 may be a partial or full deployment of most any telecommunication network, computer network or convergence thereof to which any interested member of the public can be provided with (e.g., served) communication services, including, for example, services for exchanging datagrams or packets. As such, the IB network 102 may be or include any part of a public, terrestrial wireless, and/or wireline telecommunications and/or computer network. The IB network 102 may, for example, include all or portions of the Internet, proprietary public networks, other public wired and/or wireless packet networks, etc.

As the private network or part thereof, the IB network 102 may be a partial or full deployment of most any telecommunication network, computer network or convergence thereof for serving the communication services to certain select groups, and not to the general public. Examples of such private network may include an enterprise, military or service-provider managed WAN. The IB network 102 may also be or include any part of a Virtual Private Network (“VPN”) or any other partitioning of the public and/or private network.

Although the IB network 102 is shown as being contiguous, it may be a plurality of mutually exclusive networks, including, for example, autonomous systems and/or networks. In general, the IB network 102 provides, for entities that can connect to it, the ability to exchange (e.g., send and/or receive) communications and be served communication services. To facilitate this, the IB network 102 may include a number network elements or network nodes, including, for example, an access node 118 and first, second and third network nodes 120, 122 and 124.

Each of the access, first, second and third network nodes 118-124 may, for example, be and/or function as any of switch, router, gateway, IP phone, software application running on a server (e.g. Cisco Unified Manager) and like-type network device (collectively “network device”). In general, however, the access, first, second and third network nodes 118-124 may, in addition to other functions, switch, route, forward or otherwise exchange communications with each other and/or any other of the network elements of the IB network. To facilitate exchanging such communications, each of the access, first, second and third network nodes 118-124 may communicatively couple to one another via communication links (not shown) formed from the elements of the IB network 102.

In addition to functioning as one of the network elements of the IB network 102, the access node 118 may also switch, route, forward or otherwise exchange communications from any of the network elements of the WAN 104, administrator node 106, backend server 108 and IB database 110 destined for the network elements of the IB network 102, including itself and the first, second and third network nodes 120-124. Alternatively and/or additionally, the access node 102 may also switch, route, forward or otherwise exchange communications from the network elements of the IB network 102 destined for any of the network elements of the WAN 104, administrator node 106 and back-office system 108.

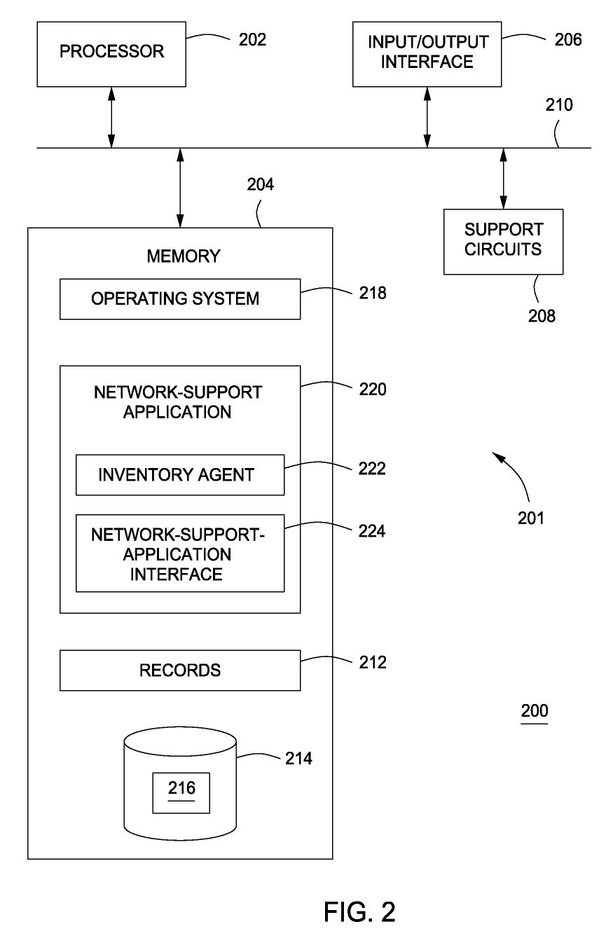

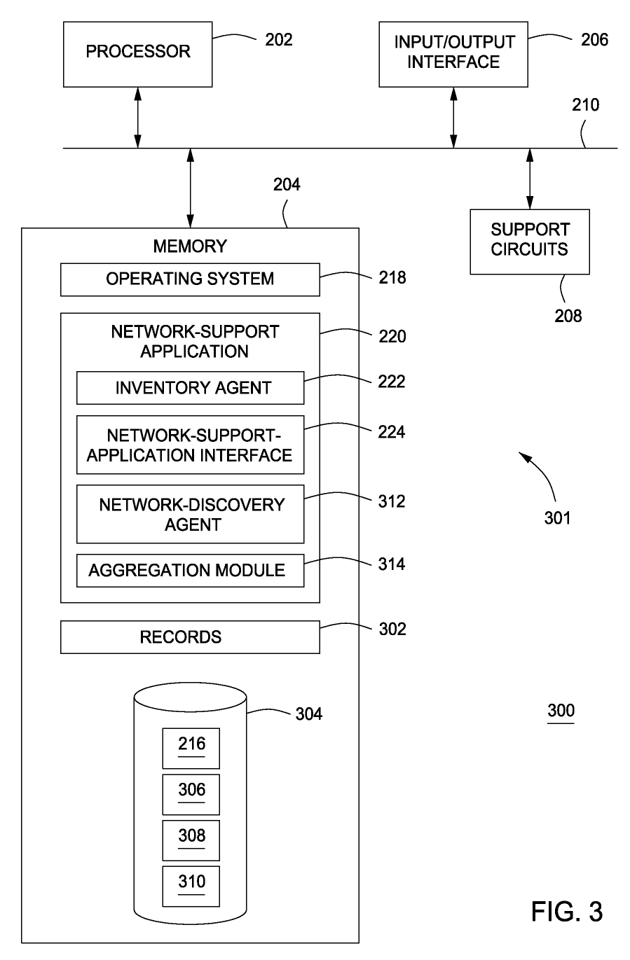

To facilitate carrying out its functions, each of the access, first, second and third network nodes 118-124 generally include a number of elements; none of which are shown in FIG. 1 for simplicity of exposition. Details of an example network node, which may be representative of any of the first, second and third network nodes 120-124, are described with reference to FIG. 2. Details of an example access node, which may be representative of the access node 118, is described with reference to FIG. 3.

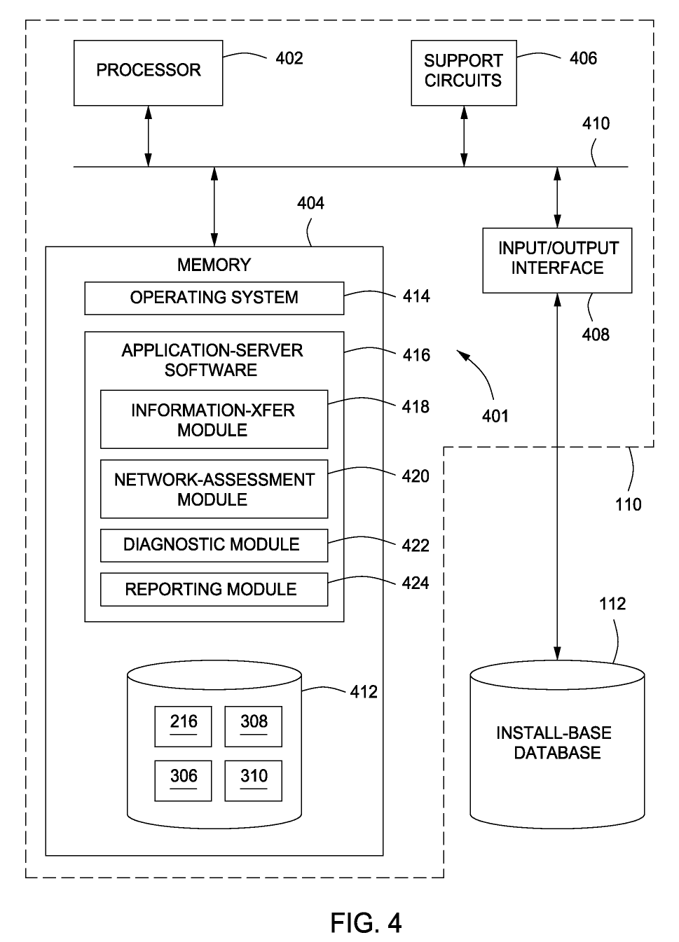

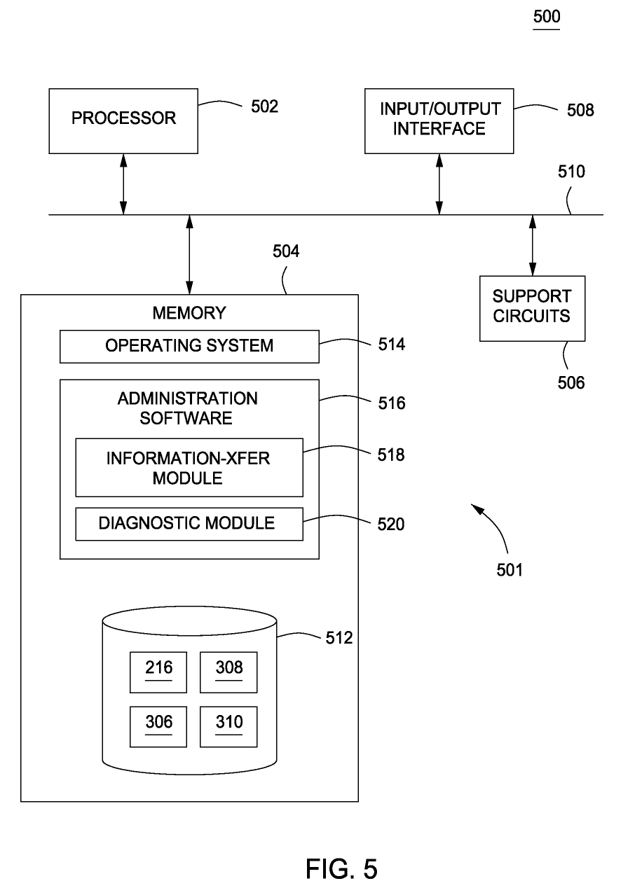

Like the access, first, second and third network nodes 118-124, each of the administrator node 106 and back-office system 108 generally includes a number of elements to carry out its functions; none of such elements are shown in FIG. 1 for simplicity of exposition. Details of an example backend server, which may be representative of the back-office system 108, are described with reference to FIG. 4. Details of an example administrator node, which may be representative of the administrator node 106, are described with reference to FIG. 5.

### Example Network Node

FIG. 2 is a block diagram illustrating an example network node 200 of an IB network, such the IB network 102 of FIG. 1. The network node 200 may embody any of the first, second and third network nodes 120-124 of FIG. 1. For convenience, the network node 200 is described with reference to the network architecture 100 of FIG. 1.

The network node 200 may be and/or function as a network device, and generally includes a number of elements, many of which are not shown for simplicity of exposition. In general, the network node 200 includes a processor-based platform that operates on any suitable network operating system, such as Cisco® Internetwork Operating System (“IOS”), and that is capable of executing software.

The network node 200 may be formed as or in a single unitary device and concentrated on a single network element. Alternatively, the network node 200 may be formed in or from one or more separate devices, and as such, may be distributed among a number of network elements. The network node 200 may be scalable; i.e., the network node 200 may employ any of a scale-up and scale-out approach. In addition, the network node 200 may be integrated into or otherwise combined with another apparatus.

As shown, the network node 200 includes a computing platform 201. The computing platform 201 includes one or more processing units (collectively “processor”) 202, memory 204, an input/output (“I/O interface”) 206 and support circuits 208. Any of the processor 202, memory 204, I/O interface 206 and support circuits 208 may communicatively couple via one or more communication links or bus 210.

The memory 204 may store one or more records or other data structures (collectively, “records”) 212 that define one or more attributes of and/or associated with the network node 200 (collectively, “network-node attributes”). These network-node attributes may include, for example, any of a serial number; product identification code; hostname; hardware information; software information, including software features and corresponding version numbers of such software features (enabled or otherwise); management information base (“MIB”); system log (“syslog”); output of command line interface (“CLI”) commands; performance measurements, which may be garnered from any of the MIB, syslog and information entered via the CLI; device setting that can be programmatically or otherwise established or adjusted for configuration and/or provisioning; configuration file; provisioning file; configuration parameter; provisioning parameter; and the like. Examples of the device settings include any of a parameter, rule, variable, expression, template, characteristic, directive (as noted below), field, reference to services, and the like.

The memory 204 may also include a data store 214. This data store 214 may, in turn, house an inventory (“network-node inventory”) 216. As described in more detail below, the network-node inventory 216 may be populated with any of the network-node attributes garnered from the records 212.

Each of the records 212, the data store 214 and/or the network-node inventory 216 may be structured as text, a table, a database, a distributed hashtable, a distributed concurrent object store, a document formed using a markup or markup-like language, such as extensible Markup Language (“XML”), extensible Markup Language-Remote Procedure Calling protocol (“XML/RPC”); or according to a given protocol, such as Hypertext Transfer Protocol (“HTTP”), Simple Object Access Protocol (“SOAP”); and the like. And each of the records 212, data store 214 and/or network-node inventory 216 may be stored (i) as or in a single file or (ii) as, in and/or across a plurality of files.

In addition to the records 212, data store 214 and/or network-node inventory 216, the memory 204 may store various software packages, including an operating system 218, such as Cisco® IOS or other network operating system; and a network-support application 220. The operating system 218 may include may include one or more programmable and/or hard-coded functions, instructions, commands, directions, code and/or control data (collectively, “directives”) for operating the network node 200. When retrieved from the memory 204 and executed by the processor 202, the operating system 218 causes the computing platform 201 to become a platform onto which the network-support application 220 can be executed.

The network-support application 220 includes one or more directives for causing the processor 202 and/or the computing platform 201 to carry out functions defined by such network-support application 220 to facilitate, at least in part, the network support for the IB network 102. The network-support application 220 may be in any of a standalone, client/server, peer-to-peer and other format. Alternatively and/or additionally, the network-support application 220 may be formed as any of an autonomous agent, intelligent agent, autonomous intelligent agent, rational agent, intelligent software agent, distributed agent, mobile agent, fuzzy agent and the like.

To facilitate its functions, the network-support application 220 may include a number of executable modules, such as an inventory agent 222. The inventory agent 222 includes one or more directives for causing the processor 202, in conjunction with other portions of the computing platform 201, to (i) search, examine or otherwise explore the records 212 for one or more of the network-node attributes, (ii) collect such network-node attributes (“collected network-node attributes”), and/or (iii) populate the network-node inventory 216 with the collected network-node attributes.

Like the network-support application 220, as a whole, the inventory agent 222 may be in any of a standalone, client/server, peer-to-peer and other format. Alternatively and/or additionally, the inventory agent 222 may be formed as any of an autonomous agent, intelligent agent, autonomous intelligent agent, rational agent, intelligent software agent, distributed agent, mobile agent, fuzzy agent and the like.

The network-support application 220 may also include a network-support-application interface 224. This network-support-application interface 224 includes one or more directives for causing the processor 202 and/or the computing platform 201 to allow the access node 118 to communicate with the network-support application 220 and/or the memory 204. This may include, for example, one or more directives for allowing the access node 118 to communicate with the network-support application 220 to trigger an execution of the inventory agent 222, and/or communicate with the memory 204 (e.g., via direct memory access or via a memory access process) to obtain the network-node inventory 216.

The network-support-application interface 224 also includes one or more directives for causing the processor 202 and/or the computing platform 201 to also allow the administrator node 106 to communicate with the network-support application 220 and/or the memory 204. This may include, for example, one or more directives for allowing the administrator node 106 to communicate with the network-support application 220 and/or the memory 204 (e.g., via direct memory access or via a memory access process) for purposes, such as troubleshooting, performing corrective actions to and/or revising the network node 200.

The network-support-application interface 224 may be formed, for example, as an application programming interface. Like the network-support application 220, as a whole, the network-support-application interface 224 may be in any of a standalone, client/server, peer-to-peer and other format. Alternatively and/or additionally, the network-support-application interface 224 may be formed as any of an autonomous agent, intelligent agent, autonomous intelligent agent, rational agent, intelligent software agent, distributed agent, mobile agent, fuzzy agent and the like.

The inventory agent 222 and network-support-application interface 224 are described herein as separate entities for ease of exposition. The inventory agent 222 and network-support-application interface 224 or functionalities thereof, however, may be intermingled or otherwise combined within the network-support application 220 or not exist at all. Alternatively, the network-support application 220 may include the same or substantially the same functionality as the inventory agent 222 and network-support-application interface 224.

As another alternative, each of the inventory agent 222 and network-support-application interface 224 may be entities (e.g., standalone software packages) separate and apart from each other and/or the network-support application 220. In addition to the various software packages, the memory 204 may also store and receive requests from the processor 202 to obtain operands, operators, dimensional values, configurations, and other data that are used by the operating system 218 and/or the network-support application 220.

To facilitate the foregoing, the memory 204 may be or employ any of random access memory, read-only memory, optical storage, magnetic storage, removable storage, erasable programmable read only memory and variations thereof, content addressable memory and variations thereof, flash memory, disk drive storage and removable storage. Although shown as a single entity, the memory 204 may more than one entity.

The support circuits 208 facilitate operation of the processor 202 and may include well-known circuitry or circuits, cache; clock circuits; power supplies and the like. The processor 202 may be one or more conventional processors, microprocessors, multi-core processors and/or microcontrollers. The processor 202 is operable to control, manipulate or otherwise interact with any of the memory 204, I/O interface 206, and support circuits 208 via the respective communication links 210 and cause the computing platform 201 to carry out the functions of the operating system 218 and/or the network-support application 220.

The communication links 210 provide for communication of any of analog and digital information among any of the processor 202, memory 204, I/O interface 206 and support circuits 208. The I/O interface 206 controls communication of information, such as the network-node inventory 216, between (shown and not shown) elements of the network node 200, such as the processor 202 and memory 204.

In addition, the I/O interface 206 controls communication of information, such as the network-node inventory 216, between elements of the network node 200 and one or more I/O devices disposed within, associated with or otherwise attached or coupled to the network node 200. Examples of the I/O devices include (i) a computer, (ii) any or any combination of storage devices, including but not limited to, a tape drive, a floppy drive, a hard disk drive or a compact disk drive, (iii) a receiver and/or a transmitter, (iv) a speaker, (v) a display, (vi) a speech synthesizer, (vii) an output port, and (viii) the like.

The I/O interface 206 may include a network-interface unit (“NIU”) (not shown). This NIU may be used to communicatively couple the network node 200 with the IB network 102. Accordingly, the NIU may be adapted for communicating over any of terrestrial wireless, satellite, and/or wireline media.

As noted above, the network node 200 may embody any of the first, second and third network nodes 120-124. While the foregoing assumes that the first, second and third network nodes 120-124 may be the same type of network devices, they may be different types of devices. For instance, the first network node 120 may be a gateway, the second network node 122 may be a switch, and the third network node 124 may be a router. Regardless of whether the first, second and third network nodes 120-124 are like-type or differing-type devices, each of them differs from another in that their attributes differ, and as such, make each of them unique. To provide differentiation herein below for the first, second and third network nodes 120-124, subscripts to the reference numerals shown in FIG. 2 are used (e.g., processor 202₁₂₀ is the processor of the first network node 120).

### Example Access Node

Referring now to FIG. 3, a block diagram illustrating an example access node 300 of an IB network, such the IB network 102 of FIG. 1, is shown. The access node 300 may embody the access nodes 118 of FIG. 1. For convenience, the access node 300 is described with reference to the network architecture 100 of FIG. 1 and the network node 200 of FIG. 2.

Like the network node 200, the access node 300 may be and/or function as a network device, and generally includes a number of elements; many of which are not shown for simplicity of exposition. In general, the access node 300 includes a processor-based platform that operates on any suitable network operating system, such as Cisco® Internetwork Operating System (“IOS”), and that is capable of executing software.

The access node 300 may be formed as or in a single unitary device and concentrated on a single network element. Alternatively, the access node 300 may be formed in or from one or more separate devices, and as such, may be distributed among a number of network elements. The access node 300 may be scalable. That is, for example, the access node 300 may employ any of a scale-up and scale-out approach. In addition, the access node 300 may be integrated into or otherwise combined with another apparatus.

As shown, the access node 300 includes a computing platform 301. The computing platform 301 includes (i) a first number of elements that are similar to the computing platform 201 of FIG. 2, and (ii) a second number of elements that are different from the computing platform 201 of FIG. 2 and/or distinct to the computing platform 301. For avoidance of repetition, the similar elements (except where described differently below) are assumed to be the same or substantially similar to (e.g., in architecture and/or function) and have the same reference numeral as the elements described with reference to the computing platform 201.

For example, the access node 300 includes elements that are similar to the processor 202, memory 204, I/O interface 206, support circuits 208 and communication links or bus 210. The memory 204, however, may store one or more records 302 that define one or more attributes of and/or associated with the access node 300 (collectively, “access-node attributes”). These access-node attributes may be the same or substantially the same as the network-node attributes, except that the access-node attributes are attributes of and/or associated with the access node 300, as opposed to the network node 200.

The memory 204 may also include a data store 304. This data store 304 may, in turn, house any of a copy of the network-node inventory 216 obtained from the network node 200, an access-node inventory 306, an aggregate inventory 308 and network-elements cache 310. As described in more detail below, the access-node inventory 306 may include or be populated with any of the access-node attributes garnered from the records 302. The aggregate inventory 308 may include or be populated with any of the network-node inventory 216 and access-node inventory 306. And the network-elements cache 310 may include or be populated with one or more identifiers (e.g., hostnames and/or other network-node attributes) of and/or associated with the network elements of the IB network 102.

Each of the records 302, the data store 304, the access-node inventory 306, the aggregate inventory 308, the network-elements cache 310 and/or network-node inventory 216 may be structured as text, a table, a database, a distributed hashtable, a distributed concurrent object store, a document formed using a markup or markup-like language, such XML, XML/RPC; or according to a given protocol, such as HTTP, SOAP; and the like. And each of the records 302, the data store 304, the access-node inventory 306, aggregate inventory 308, network-elements cache 310 and/or network-node inventory 216 may be stored (i) as or in a single file or (ii) as, in and/or across a plurality of files.

Like the network node 200, the network-support application 220 includes one or more directives for causing the processor 202 and/or the computing platform 301 to carry out functions defined by such network-support application 220 so as to facilitate, at least in part, the network support for the IB network 102. In addition to the inventory agent 222 and network-support-application interface 224, the network-support application 220 may include a network discovery agent 312 and an aggregation module 314.

Analogous to the network node 200, the inventory agent 222 includes one or more directives for causing the processor 202, in conjunction with other portions of the computing platform 201, to form and/or revise the access-node inventory 306. This may include one or more directives to (i) search, examine or otherwise explore the records 302 for one or more of the access-node attributes, (ii) collect such access-node attributes (“collected access-node attributes”), and/or (iii) populate the access-node inventory 306 with the collected access-node attributes.

The network-discovery agent 312 includes one or more directives for causing the processor 202 and/or computing platform 301 to perform a network discovery on the IB network 102 to discover the presence of the network elements of the IB network 102. This may include, for example, one or more directives to cause the computing platform 301 to (i) search, examine or otherwise explore the IB network 102 for one or more of network elements, including, for example, the first, second and/or third network nodes 120-124; (ii) collect, for the network elements located, the respective identifiers (“collected identifiers”), and/or (iii) populate the network-element cache 310 with the collected identifiers.

The network-discovery agent 312 may be formed in accordance with one or more protocols, including, for example, a network-discovery protocol, such as Cisco® Discovery Protocol, and the like. The network-discovery agent 312, like the network-support application 220, as a whole, may be in any of a standalone, client/server, peer-to-peer and other format. Alternatively and/or additionally, the network-discovery agent 312 may be formed as any of an autonomous agent, intelligent agent, autonomous intelligent agent, rational agent, intelligent software agent, distributed agent, mobile agent, fuzzy agent and the like.

The aggregation module 314 may include one or more directives for causing the processor 202, in conjunction with other portions of the computing platform 301, to form and/or revise the aggregate inventory 308. The aggregation module 314 may include, for example, one or more directives to (i) aggregate some or the entire access-node inventory 306 with some or the entire network-node inventory 216 (“aggregate information”), and (ii) populate the aggregate inventory 308 with such aggregate information.

The aggregation module 314, like the network-support application 220, as a whole, may be in any of a standalone, client/server, peer-to-peer and other format. Alternatively and/or additionally, the aggregation module 314 may be formed as any of an autonomous agent, intelligent agent, autonomous intelligent agent, rational agent, intelligent software agent, distributed agent, mobile agent, fuzzy agent and the like.

The network-support-application interface 224 includes one or more directives for causing the processor 202 and/or the computing platform 301 to allow the any of the administrator node 106 and backend server 108 to communicate with the network-support application 220 and/or the memory 204. Such directives may include, for example, one or more directives for allowing the any of the administrator node 106 and backend server 108 to communicate with the network-support application 220 to trigger an execution of any of the inventory agent 222, network-discovery agent 312 and aggregation module 314.

The network-support-application interface 224 may also include one or more directives to allow the administrator node 106 and backend server 108 to communicate with the memory 204 (e.g., via direct memory access or via a memory access process) to obtain any of the network-node inventory 216, access-node inventory 306, aggregate inventory 308 and network-elements cache 310. The network-support-application interface 224 may also include one or more directives for causing the processor and/or computing platform 301 to allow the administrator node 106 to communicate with the network-support application 220 and/or the memory 204 for purposes, such as troubleshooting, performing corrective actions to and/or revising the access node 300.

The inventory agent 222, network-support-application interface 226, network-discovery agent 312 and aggregation module 314 are described herein as separate entities for ease of exposition. The inventory agent 222, network-support-application interface 226, network-discovery agent 312 and aggregation module 314 or functionalities thereof, however, may be intermingled or otherwise combined within the network-support application 220 or not exist at all. Alternatively, the network-support application 220 may include the same or substantially the same functionality as the inventory agent 222, network-support-application interface 226, network-discovery agent 312 and aggregation module 314. As another alternative, each of the inventory agent 222, network-support-application interface 226, network-discovery agent 312 and aggregation module 314 may be entities (e.g., standalone software packages) separate and apart from each other and/or the network-support application 220.

Like the network node 200, the I/O interface 206 controls communication of information, such as any of the network-node inventory 216, access-node inventory 306, aggregate inventory 308 and network-elements cache 310, between (shown and not shown) elements of the access node 300, such as the processor 202 and memory 204. The I/O interface 206 also controls communication of information, such as any of the network-node inventory 216, access-node inventory 306, aggregate inventory 308 and the network-elements cache 310, between elements of the access node 300 and one or more I/O devices disposed within, associated with or otherwise attached or coupled to the access node 300. Examples of the I/O devices include (i) a computer, (ii) any or any combination of storage devices, including but not limited to, a tape drive, a floppy drive, a hard disk drive or a compact disk drive, (iii) a receiver and/or a transmitter, (iv) a speaker, (v) a display, (vi) a speech synthesizer, (vii) an output port, and (viii) the like.

In addition to communicatively coupling the access node 300 with the IB network 102, the NIU of the I/O interface 206 may communicatively couple the access node 300 to the WAN 104 to facilitate exchanging communications with any of the administrator node 106, backend server 108 and IB database 110. The NIU in conjunction with the operating system 218 and the network-support application 220 may provide a conduit to the other network elements of the IB network 102. This way, such other network elements, including the first, second and third network nodes 120-124, and the administrator node 106, backend server 108 and IB database 110 may exchange communications.

### Example Back-Office System

FIG. 4 is a block diagram illustrating an example of a back-office system 400 for facilitating network support for an IB network, such as the IB network 102. The back-office system 400 may embody the back-office system 108 of FIG. 1. For convenience, the back-office system 400 is described with reference to the network architecture 100 of FIG. 1, the network node 200 of FIG. 2 and the access node 300 of FIG. 3.

The back-office system 400 may facilitate network support for the IB network 102 by carrying out certain support functions, including, for example, performing any of network assessment; diagnostics and remediation; configuration management; provisioning management; reporting and other like-type functions. To facilitate such functions, the back-office system 400 may include the backend server 110 and IB database 112; which may communicatively couple via communication link 402.

The IB database 112 may store information relating to configuration and provisioning of the IB network 102, including information relating to products and services provided to the IB network 102, such as service level agreements, equipment descriptions and/or attributes, wiring information, transmission information, licensing information and information related to the physical and logical architectures of IB network 102. The IB database 112 may also store information, such as internet protocol (“IP”), medium-access control (“MAC”) and/or other addresses of the network elements of the IB network 102. The IB database 112 may also store other data relating to operations support and monitoring of IB network 102, such as utilization statistics from IB network 102.

The IB database 112 may be maintained in one or more number of storage devices. These storage devices may be arranged as, be configured to and/or otherwise operate as any of a redundant array of independent disks (“RAID”), a storage area network (“SAN”) array and the like. Alternatively, the storage devices may be arranged as, be configured to and/or otherwise operate as any of random access memory, read-only memory, optical storage, magnetic storage, removable storage, erasable programmable read only memory and variations thereof, content addressable memory and variations thereof, flash memory, disk drive storage, removable storage and the like. And although shown directly connected to backend server 110, the storage devices (and, in turn, the IB database 112) may be integrated with or remotely connected to the backend server 110.

To facilitate its functions, the backend server 400 may include one or more servers, including an application server 401. The application server 401 may be deployed in one or more general or specialty purpose computers, personal computers, mainframes, minicomputers, server-type computers and/or any a processor-based platform that operates on any suitable operating system, such as Microsoft® Windows® and/or Linux; and that is capable of executing software.

The application server 401 may include a large number of elements; many of which are not shown in FIG. 4 for simplicity of exposition. The elements of application server 401 may be formed in a single unitary device and concentrated on a single server, client, peer or other type network node. Alternatively, the elements of the application server 401 may be formed from two or more separate devices, and as such, may be distributed among a number of server, client, peer or other type network nodes.

As shown, the application server 401 includes one or more processing units (collectively “processor”) 402, memory 404, supports circuits 406, I/O interface 408 and communication links or bus 410. The processor 402 may be one or more conventional processors, microprocessors, multi-core processors, microcontrollers and the like.

The communication links 410 provides for communications of digital information among the processor 402, memory 404, support circuits 406, I/O interface 408 and other portions of the application server 401 (not shown). The support circuits 406 facilitate operation of the processor 402, and may include well-known circuitry or circuits, including, for example, cache; clock circuits; power supplies and the like.

The I/O interface 408 provides an interface to control the communications of digital information between components of the application server 401 (shown and not shown). In addition, the I/O interface 408 provides an interface to control the communications of digital information between I/O devices (not shown) associated with or otherwise attached to the application server 401. The I/O devices (not shown) may be embodied as any or any combination of (i) storage devices, including but not limited to, a tape drive, a floppy drive, a hard disk drive or a compact disk drive, (ii) a receiver, (ii) a transmitter, (iii) a speaker, (iv) a display, (v) a speech synthesizer, (vi) an output port, and (vii) a pointing device, such as a mouse, joystick, trackball, touchpad, pointing stick, light pen, head pointer, soap mouse, eye tracking devices, digitizing tablet and stylus, data glove that translates the user's movements to computer gestures; and a key-in device, such as a keyboard or a touchpad, (vii) and the like.

The I/O interface 408 also includes one or more one or more NIUs. The NIUs facilitate exchange of any of the network-node inventory 216, access-node inventory 306, aggregate inventory 308 and network-elements cache 310 with the access node 300. Accordingly, the NIUs may be adapted for communicating over terrestrial wireless, satellite, and/or wireline media.

The memory 404 may include a data store 412. This data store 412 may, in turn, house any of a copy of the network-node inventory 216, a copy of the access-node inventory 306, a copy of the aggregate inventory 308 and a copy of the network-elements cache 310.

The memory 404 may store and may be queried by the processor 402 to obtain various software packages, such as operating system 414 and application-server software 416. The operating system 414 may include may include one or more directives for operating the application server 401. When retrieved from the memory 404 and executed by the processor 402, the operating system 414 causes the application server 401 to become a platform onto which the application-server software 416 can be executed.

The application-server software 416 includes one or more directives for causing the processor 402 and/or the application server 401 to carry out functions defined by such application-server software 416 to facilitate, at least in part, the network support for the IB network 102. The application-server software 416 may be in any of a standalone, client/server, peer-to-peer and other format.

The application-server software 416 may include a number of executable modules to facilitate performing its functions. These modules may include, for example, an information-transfer module 418, a network-assessment module 420, a diagnostic module 422 and a reporting module 424.

The information-transfer module 418 includes directives to cause the application server 401 to transfer to the data store 414 any of the network-node inventory 216, access-node inventory 306, the aggregate inventory 308 and network-elements cache 310 (or collectively “acquired content”) received from the access node 300. Such directives may be adapted to cause the application server 401 to interface with the network-support application 220 of the access node 300 and query and/or trigger the access node 300 to provide the acquired content. Alternatively, the directives may be adapted to cause the application server 401 to obtain the acquired content without making a request. In other words, the directives may be adapted to receive the acquired content being pushed to it from the access node 300. As another alternative, the directives may be adapted to cause the application server 401 (in conjunction with corresponding directives of the network-support application 220 of the access node 300) to exchange the acquired content using a synchronization routine.

The network-assessment module 420 includes one or more directives for causing the application server 401 to perform an assessment of the IB network 102. Such directives may be adapted to cause the application server 401 to (i) obtain, from the data store 412, any of the acquired content; (ii) obtain, from the IB database 112, information for assessing the acquired content (“assessment information”); and (iii) correlate, assess or otherwise evaluate the acquired content in accordance with the assessment information.

The diagnostic module 422 includes directives to cause the application server 401 to perform a diagnostic of the IB network 102. These directives may be adapted to cause the application server 401 to (i) obtain, from the data store 412, any of the acquired content; (ii) obtain, from the IB database 112, information for diagnosing one or more of the elements of the IB network 102 (“diagnostic information”); (iii) evaluate the acquired content in accordance with the diagnostic information to determine issues for remediation, if any; and, if necessary, (iv) determine remediation for such issues.

The reporting module 424 includes directives to cause the application server 401 to issue one or more reports regarding the IB network 102. These directives may be adapted to cause the application server 401 to issue the reports responsive to (i) performing the assessment of the IB network 102 and/or (ii) performing the diagnostic of the IB network 102.

To facilitate the foregoing, the memory 404 may be or employ any of random access memory, read-only memory, optical storage, magnetic storage, removable storage, erasable programmable read only memory and variations thereof, content addressable memory and variations thereof, flash memory, disk drive storage and removable storage. Although shown as a single entity, the memory 404 may more than one entity.

### Example Administrator Node

FIG. 5 is a block diagram illustrating an example administrator node 500 for facilitating network support for an IB network, such as the IB network 102. The administrator node 500 may embody the administrator node 106 of FIG. 1. For convenience, the administrator node 500 is described with reference to the network architecture 100 of FIG. 1, the network node 200 of FIG. 2, the access node 300 of FIG. 3 and the back-office system 400 of FIG. 4.

The administrator node 500 may be, for example, any of a personal computer; portable computer, handheld computer; mobile phone, digital assistant, personal digital assistant, cellular phone, smart phone, digital tablet, laptop computer, Internet appliance and the like. In general, the administrator node 500 includes a processor-based platform that operates on any suitable operating system, such as Microsoft® Windows®, Linux and/or Symbian; and that is capable of executing software.

The administrator node 500 may, however, include a large number of elements; many of which are not shown in FIG. 5 for simplicity of exposition. The elements of administrator node 500 may be formed in a single unitary device and concentrated on a single server, client, peer or other type network node. Alternatively, the elements of the administrator node 500 may be formed from two or more separate devices, and as such, may be distributed among a number of server, client, peer or other type network nodes.

As shown, the administrator node 500 includes a computing platform 501. The computing platform 501 includes one or more processing units (collectively “processor”) 502, memory 504, supports circuits 506, I/O interface 508 and communication links or bus 510. The processor 502 may be one or more conventional processors, microprocessors, multi-core processors, microcontrollers and the like.

The communication links 510 provides for communications of digital information among the processor 502, memory 504, support circuits 506, I/O interface 508 and other portions of the administrator node 500 (not shown). The support circuits 506 facilitate operation of the processor 502, and may include well-known circuitry or circuits, including, for example, cache; clock circuits; power supplies and the like.

The I/O interface 508 provides an interface to control the communications of digital information between components of the administrator node 500 (shown and not shown). In addition, the I/O interface 508 provides an interface to control the communications of digital information between I/O devices (not shown) associated with or otherwise attached to the administrator node 500. The I/O devices (not shown) may be embodied as any or any combination of (i) storage devices, including but not limited to, a tape drive, a floppy drive, a hard disk drive or a compact disk drive, (ii) a receiver, (ii) a transmitter, (iii) a speaker, (iv) a display, (v) a speech synthesizer, (vi) an output port, and (vii) a pointing device, such as a mouse, joystick, trackball, touchpad, pointing stick, light pen, head pointer, soap mouse, eye tracking devices, digitizing tablet and stylus, data glove that translates the user's movements to computer gestures; and a key-in device, such as a keyboard or a touchpad, (vii) and the like.

The I/O interface 508 also includes one or more one or more NIUs. The NIUs facilitate communications with the WAN 104. Accordingly, the NIUs may be adapted for communicating over terrestrial wireless, satellite, and/or wireline media.

The memory 505 may include a data store 512. The data store 512 may, in turn, house any of a copy of the network-node inventory 216, a copy of the access-node inventory 306, a copy of the aggregate inventory 308, a copy of the network-elements cache 310, and information from the IB database 112 and/or the backend server 110.

The memory 504 may store and may be queried by the processor 502 to obtain various software packages, such as operating system 514 and admin software 516. The operating system 514 may include may include one or more directives for operating the administrator node 500. When retrieved from the memory 504 and executed by the processor 502, the operating system 514 causes the computing platform 501 to become a platform onto which the admin software 516 can be executed.

The admin software 516 includes one or more directives for causing the processor 502 and/or the computing platform 501 to carry out functions defined by such admin software 516 to facilitate, at least in part, the network support for the IB network 102. The admin server software 516 may be in any of a standalone, client/server, peer-to-peer and other format.

The admin software 516 may include a number of executable modules to facilitate performing its functions. These modules may include, for example, an information-transfer module 518 and a diagnostic module 520.

The information-transfer module 518 includes directives to cause the computing platform 501 to transfer from the backend server 110 to the data store 514 any of the acquired content. Such directives may be adapted to cause computing platform 501 to interface with the backend server 110 and query and/or trigger the backend server 110 to provide the acquired content. Alternatively, the directives may be adapted to cause the computing platform 501 to transfer the acquired content without requesting it. In other words, the directives may be adapted to receive the acquired content being pushed to it from the backend server 110. As another alternative, the directives may be adapted to cause the computing platform 501 (in conjunction with corresponding directives of the application server software 416 of the backend server 110) to exchange the acquired content using a synchronization routine.

The information-transfer module 518 may, alternatively, include directives to cause the computing platform 501 to transfer from the access node 300 to the data store 514 any of the acquired content. Such directives may be adapted to cause computing platform 501 to interface with the access node 300 and query and/or trigger the access node 300 to provide the acquired content. Alternatively, the directives may be adapted to cause the computing platform 501 to transfer the acquired content without requesting it (i.e., be adapted to receive the acquired content being pushed to it from the access node 300). As another alternative, the directives may be adapted to cause the computing platform 501 (in conjunction with corresponding directives of the network-support application 220 of the access node 300) to exchange the acquired content using a synchronization routine.

The diagnostic module 520 includes directives to cause the computing platform 501 to perform a diagnostic of the IB network 102. These directives may be adapted to cause the computing platform 501 to (i) obtain, from the data store 514, any of the acquired content; (ii) obtain the diagnostic information from the IB database 112; (iii) evaluate the acquired content in accordance with the diagnostic information to determine issues for remediation, if any; and, if necessary, (iv) determine remediation for such issues.

The reporting module 424 includes directives to cause the application server 401 to issue one or more reports regarding the IB network 102. These directives may be adapted to cause the application server 401 to issue the reports responsive to (i) performing the assessment of the IB network 102 and/or (ii) performing the diagnostic of the IB network 102.

To facilitate the foregoing, the memory 504 may be or employ any of random access memory, read-only memory, optical storage, magnetic storage, removable storage, erasable programmable read only memory and variations thereof, content addressable memory and variations thereof, flash memory, disk drive storage and removable storage. Although shown as a single entity, the memory 504 may more than one entity.

### Example Operation

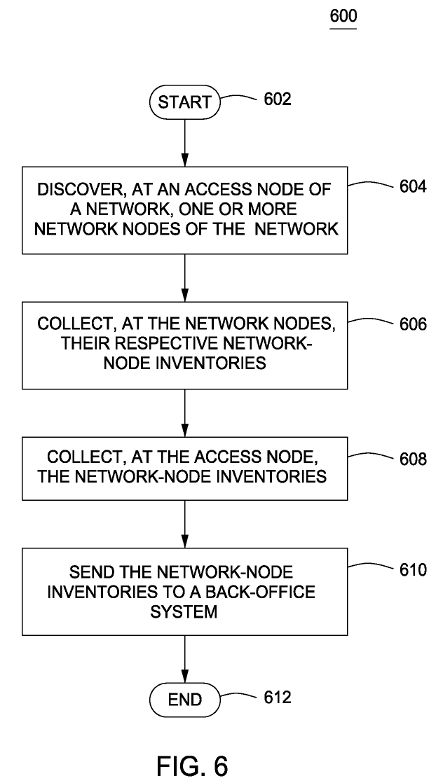

FIG. 6 is a flow diagram illustrating an example flow 600 for facilitating network support for an IB network, such as the IB network 102. For convenience, the following describes the flow 600 with reference to with reference to the network architecture 100 of FIG. 1, the network node 200 of FIG. 2, the access node 300 of FIG. 3 and the back-office system 400 of FIG. 4. The flow 600 may be carried out by other architectures as well.

The flow 600 starts at termination block 602. Prior to termination block 602, each of the access node 118; first, second and third network nodes 120-124; administrator node 106; and back-office system 108, including the backend server 110 and IB database 112, to become operative, such that their various software packages are retrieved from their respective memories and executed by their respective processors, thereby, making each of the access node 118; first, second and third network nodes 120-124; administrator node 106; and backend server 110 specially programmed computers to carry out any of the functions noted above and below. Any reference below to the various software packages assumes that such software package is (and directives therein are) under execution.

Sometime after termination block 602, the flow 602 may transition to process block 604. At the process block 604, the access node 118 discovers one or more network nodes of the IB network 102. To facilitate this, the network-discovery agent 312, in accordance with the network-discovery protocol, searches, examines or otherwise explores the IB network 102 and detects the first, second and/or third network nodes 120-124. In addition, the network-discovery agent 312, in accordance with the network-discovery protocol, (i) collects the respective identifiers (e.g., hostnames) for such network nodes 120-124, and (ii) populates the network-element cache 310 with the collected identifiers. After the process block 604, the flow 600 may transition to process block 606.

At the process block 606, one or more of the first, second and third network nodes 120-124 collect their respective network-node inventories 216₁₂₀, 216₁₂₂ and 216₁₂₄. To facilitate this, the inventory agents 222₁₂₀, 222₁₂₂ and 222₁₂₄ (i) search, examine or otherwise explore their records 212₁₂₀, 212₁₂₂ and 212₁₂₄ for their network-node attributes, (ii) collect such network-node attributes, and/or (iii) populate the network-node inventories 216₁₂₀, 216₁₂₂ and 216₁₂₄ with the collected network-node attributes. The first, second and third network nodes 120-124 may collect their respective network-node inventories 216₁₂₀, 216₁₂₂ and 216₁₂₄ autonomously. Alternatively, the first, second and third network nodes 120-124 may collect their respective network-node inventories 216₁₂₀, 216₁₂₂ and 216₁₂₄ responsive to being triggered by the access node 118 via their network-support-application interfaces 224₁₂₀, 224₁₂₂ and 224₁₂₄. After the process block 606, the flow 600 may transition to process block 608.

At the process block 608, the access node 118 collects the network-node inventories 216₁₂₀, 216₁₂₂ and 216₁₂₄. To facilitate this, the network-support application 220₁₁₈ may interface with the network-support-application interfaces 224₁₂₀, 224₁₂₂ and 224₁₂₄ and obtain the network-node inventories 216₁₂₀, 216₁₂₂ and 216₁₂₄ from memories 204₁₂₀, 204₁₂₂ and 204₁₂₄. Alternatively, the network-support application 220₁₁₈ may obtain the network-node inventories 216₁₂₀, 216₁₂₂ and 216₁₂₄ as a result of the network-support-application interfaces 224₁₂₀, 224₁₂₂ and 224₁₂₄ pushing or otherwise reporting the network-node inventories 216₁₂₀, 216₁₂₂ and 216₁₂₄ to the access node 118. After the process block 608, the flow 600 may transition to process block 610.

At the process block 610, the access node 118 sends the network-node inventories 216₁₂₀, 216₁₂₂ and 216₁₂₄ to the back-office system 108. To facilitate this, the network-support-application interface 224₁₁₈ communicates the network-node inventories 216₁₂₀, 216₁₂₂ and 216₁₂₄ to the backend server 110 autonomously. Alternatively, the network-support-application interface 224₁₁₈ may allow the backend server 110 to request that the network-support application 220₁₁₈ send the network-node inventories 216₁₂₀, 216₁₂₂ and 216₁₂₄ to it. As another alternative, the network-support-application interface 224₁₁₈ may allow the backend server 110 to communicate with the memory 204₁₁₈ (e.g., via direct memory access or via a memory access process) to obtain network-node inventories 216₁₂₀, 216₁₂₂ and 216₁₂₄.

After the process block 610, the flow 600 may transition to termination block 612. At termination block 612, the flow 600 terminates. Alternatively, the flow 600 may be repeated periodically, in continuous fashion, or upon being triggered as a result of a condition, such as an impetus from any of the access node 118, back-office system 108 and administrator node 106. As described in more detail below, the back-office system 108 may use the network-node inventories 216₁₂₀, 216₁₂₂ and 216₁₂₄ to perform any of network assessment; diagnostics and remediation; configuration management; provisioning management; reporting and other like-type functions.

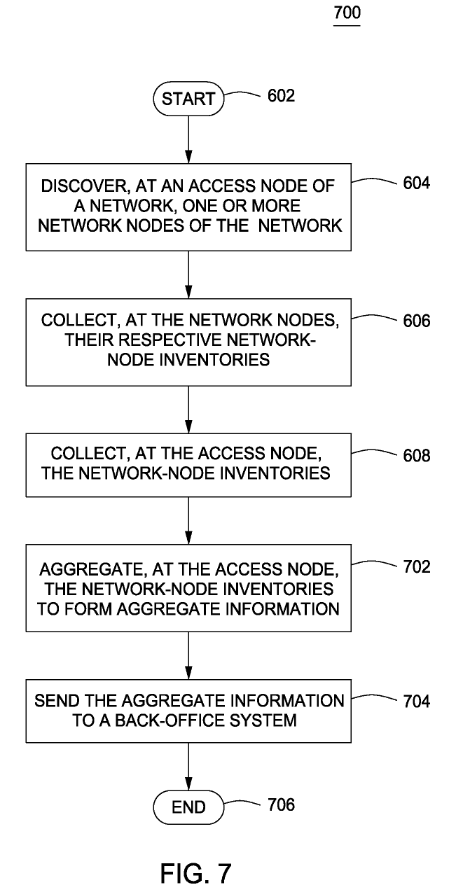

Referring now to FIG. 7, a flow diagram illustrating an example flow 700 for facilitating network support for an IB network, such as the IB network 102, is shown. For convenience, the following describes the flow 700 with reference to with reference to the network architecture 100 of FIG. 1, the network node 200 of FIG. 2, the access node 300 of FIG. 3 and the back-office system 400 of FIG. 4. The flow 700 may be carried out by other architectures as well. In addition, the flow 700 is similar to the flow 600 of FIG. 6, except as described herein below.

After the process block 608, the flow 700 may transition to process block 702. At the process block 702, the access node 118 aggregates the network-node inventories 216₁₂₀, 216₁₂₂ and 216₁₂₄. To facilitate this, the aggregation module 314 may (i) aggregate some or the entire access-node inventory 306 with some or the entire network-node inventory 216 (“aggregate information”), and (ii) populate the aggregate inventory 308 with such aggregate information. After the process block 702, the flow 700 may transition to process block 704.

At the process block 704, the access node 118 sends the aggregate information to the back-office system 108. To facilitate this, the network-support-application interface 224₁₁₈ communicates the aggregate information to the backend server 110 autonomously. Alternatively, the network-support-application interface 224₁₁₈ may allow the backend server 110 to request that the network-support application 220₁₁₈ send the aggregate information to it. As another alternative, the network-support-application interface 224₁₁₈ may allow the backend server 108 to communicate with the memory 204₁₁₈ (e.g., via direct memory access or via a memory access process) to obtain aggregate information.

After the process block 704, the flow 700 may transition to termination block 706. At termination block 706, the flow 700 terminates. Alternatively, the flow 700 may be repeated periodically, in continuous fashion, or upon being triggered as a result of a condition, such as an impetus from any of the access node 118, back-office system 108 and administrator node 106. As described in more detail below, the back-office system 108 may use the aggregate information to perform any of network assessment; diagnostics and remediation; configuration management; provisioning management; reporting and other like-type functions.

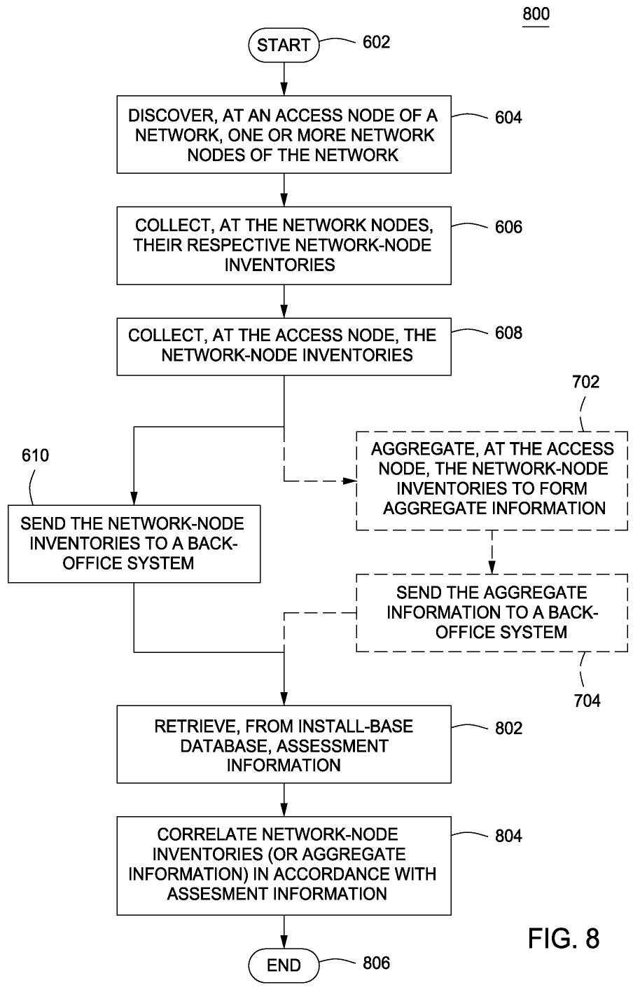

FIG. 8 is a flow diagram illustrating an example flow 800 for facilitating network support for an IB network, such as the IB network 102. For convenience, the following describes the flow 800 with reference to with reference to the network architecture 100 of FIG. 1, the network node 200 of FIG. 2, the access node 300 of FIG. 3 and the back-office system 400 of FIG. 4. The flow 800 may be carried out by other architectures as well. In addition, the flow 800 is similar to the flow 600 of FIG. 6 and the flow 700 of FIG. 7, except as described herein below.

After the process block 608, the flow 800 may transition to process block 802 after the process block 610 or, alternatively, after the process block 704. At the process block 802, the back-end server 110 retrieves the assessment information from the IB database 112. To facilitate this, the application-server software 416 of the application server 401 causes its network assessment module 420 to query and obtain the assessment information from the IB database 112. The network assessment module 420 may tailor its query and/or obtain the assessment information based on the acquired information (i.e., any of the network-node inventories 216₁₂₀, 216₁₂₂ and 216₁₂₄ from the process block 610, and the aggregate information from the process block 704). After obtaining the assessment information, the flow 800 may transition to process block 804.

At the process block 804, the backend server 110 correlates the acquired information in accordance with the assessment information. To facilitate this, the application-server software 416 causes its network assessment module 420 to correlate, assess or otherwise evaluate (collectively “correlate”) the acquired content in accordance with the assessment information. When so correlating, the network assessment module 420 may establish a basis for an install base of the IB network 102 (“IB-network install base”).

For example, the acquired content may include information indicative of a current state of the IB-network install base, a type of supported contract (e.g. Next Business Day guaranteed device replacement), and the assessment information may include information indicative of a contracted state for the IB-network install base. By correlating the information indicative of the current state with that of the contracted state, the network assessment module 420 may determine that the current state of the IB network 102 is in line with the contracted state. Determining that the current state of the IB network is in line with the contracted state is important because performance of certain terms of a contract (e.g., 4-hour guaranteed device replacement) may require meeting conditions precedent (e.g., the location of the device be within a given service area). If the current state is not in line with the contracted state, then no or, alternatively, reduced performance within the terms of the contract is required.

After the process block 804, the flow 800 may transition to termination block 806. At termination block 806, the flow 800 terminates. Alternatively, the flow 800 may be repeated periodically, in continuous fashion, or upon being triggered as a result of a condition, such as an impetus from any of the access node 118, back-office system 108 and administrator node 106.

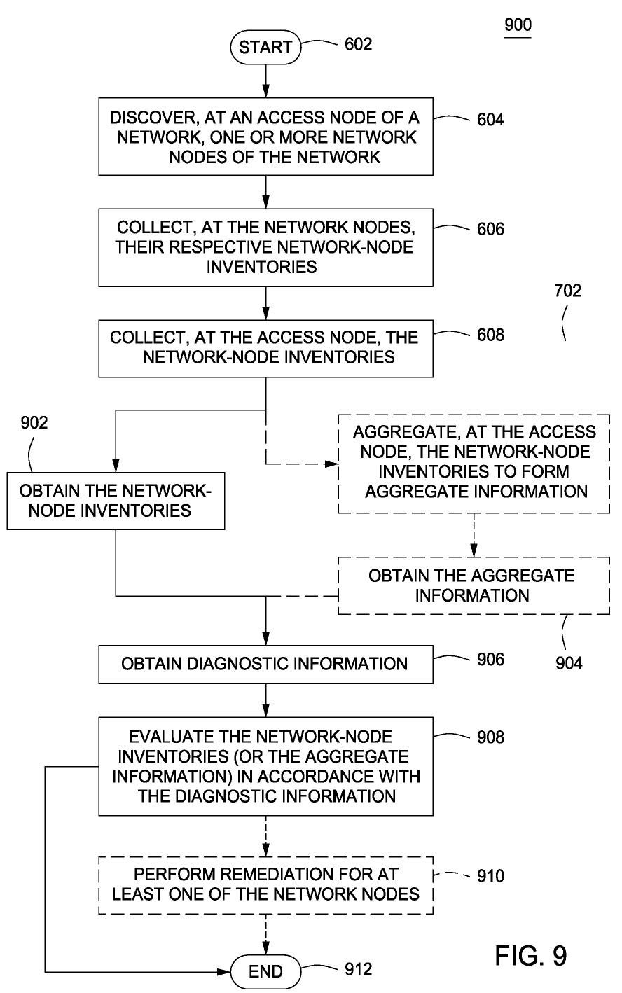

FIG. 9 is a flow diagram illustrating an example flow 900 for facilitating network support for an IB network, such as the IB network 102. For convenience, the following describes the flow 900 with reference to with reference to the network architecture 100 of FIG. 1, the network node 200 of FIG. 2, the access node 300 of FIG. 3 and the back-office system 400 of FIG. 4. The flow 900 may be carried out by other architectures as well. In addition, the flow 900 is similar to the flow 600 of FIG. 6 and the flow 700 of FIG. 7, except as described herein below.

After the process block 608, the flow 900 may transition to process block 902 or, alternatively, to the process block 702. At the process block 902, the back-office system 108 obtains, retrieves or otherwise acquires (collectively “obtains”) the network-node inventories 216₁₂₀, 216₁₂₂ and 216₁₂₄ from the access node 118. To facilitate this, the application-server software 416 of the application server 401 may use its information-transfer module 418.

The information-transfer module 418 may, for example, obtain the network-node inventories 216₁₂₀, 216₁₂₂ and 216₁₂₄ by interfacing with and having the network-support-application interface 224₁₁₈ communicate such inventories 216₁₂₀, 216₁₂₂ and 216₁₂₄ to the backend server 110 autonomously and/or via the synchronization routine. Alternatively, the information-transfer module 418 may request and receive the network-node inventories 216₁₂₀, 216₁₂₂ and 216₁₂₄ from the network-support-application interface 224₁₁₈ or the memory 204₁₁₈

As another alternative, the information-transfer module 418 may establish respective communications with the network-support-application interfaces 224₁₂₀, 224₁₂₂ and 224₁₂₄ or the memories 204₁₂₀ 204₁₂₂ and 204₁₂₄ of the first, second and third network nodes 120, 122 and 124. The information-transfer module 418 may establish such communications with the network-support-application interfaces 224₁₂₀, 224₁₂₂ and 224₁₂₄ or memories 204₁₂₀ 204₁₂₂ and 204₁₂₄ with or without interfacing with the network-support-application interface 224₁₁₈ of the access node 118. After establishing the communications, the information-transfer module 418 may interface with, request and receive the network-node inventories 216₁₂₀, 216₁₂₂ and 216₁₂₄ from the network-support-application interfaces 224₁₂₀, 224₁₂₂ and 224₁₂₄ or the memories 204₁₂₀ 204₁₂₂ and 204₁₂₄.

After the process block 902, the flow 900 may transition to process block 906. As noted above, however, the flow 900 may transition from the process block 608 to the process block 702, instead of the process block 902. At the process block 702, the access node 118 aggregates the network-node inventories 216₁₂₀, 216₁₂₂ and 216₁₂₄ to form the aggregate information, as noted above with respect to flow 700 of FIG. 7. After the process block 702, the flow 700 may transition to process block 904.

At the process block 904, the back-office system 108 obtains the aggregate information from the access node 118. To facilitate this, the application-server software 416 of the application server 401 may use its information-transfer module 418.

The information-transfer module 418 may, for example, obtain the aggregate information by interfacing with and having the network-support-application interface 224₁₁₈ communicate such aggregate information to the backend server 110 autonomously and/or via the synchronization routine. Alternatively, the information-transfer module 418 may request and receive the aggregate information from the network-support-application interface 224₁₁₈ or the memory 204₁₁₈.

After obtaining the acquired information (i.e., any of the network-node inventories 216₁₂₀, 216₁₂₂ and 216₁₂₄ from the process block 902 and the aggregate information from the process block 904), the flow 900 may transition to process block 906. At the process block 906, the back-end server 110 obtains the diagnostic information from the IB database 112. To facilitate this, the application-server software 416 of the application server 401 causes its diagnostic module 422 to query and obtain the diagnostic information from the IB database 112. The diagnostic module 422 may tailor its query and/or obtain the diagnostic information based on the acquired information (i.e., based on any of the network-node inventories 216₁₂₀, 216₁₂₂ and 216₁₂₄ from the process block 902 and the aggregate information from the process block 904). After obtaining the diagnostic information, the flow 900 may transition to process block 908.

At the process block 908, the backend server 110 evaluates the acquired content in accordance with the diagnostic information. To facilitate this, the application-server software 416 causes its diagnostic module 422 to evaluate the acquired content in accordance with the diagnostic information to determine issues for remediation (“remediation issues”), if any.

After the process block 908, the flow 900 may transition to termination block 912 or, alternatively, to optional process block 910. At the process block 910, the back-office system 108 performs remediation (e.g., enacts one or more corrective actions) for at least one of the first, second and third network nodes 120-124 in view of the remediation issues. For example, the back-office system 108 may perform remediation for the first network node 120 because the first network node 120 is not operating correctly and/or because the first network node 120 does not have one or more up-to-date network-node attributes (e.g., an old version of software).

To facilitate the remediation, the application-server software 416 may establish a communication with the network-support-application interface 224₁₂₀. The application-server software 416 generally does so using the access node 118 as a conduit. The application-server software 416, however, may establish the communication with or without interfacing with the network-support-application interface 224₁₁₈ of the access node 118.

After establishing the communication, the diagnostic module 422 and/or information-transfer module 418 may interface with and/or provide (e.g., by pushing) remediation information to the network-support-application interface 224₁₂₀ and/or the memories 204₁₂₀. The remediation information may include information and/or directives for remediating any of the remediation issues. The remediation information may include, for example, any of a revision, update, upgrade, workaround, patch, error-correction, bug fix and the like (collectively “revisions”) for the first network node 120. The remediation information may also include any of a copy of network-node attributes originally provided with the first network node 120 and one or more copies of the network-node attributes of the first network node 120 collected via the flow 600 (FIG. 6) or the flow 700 (FIG. 7) and subsequently stored on the back-office system 108.

Although not described in detail, the back-office system 108 may perform remediation for each of the second and third network nodes 122 and 124 in much the same way as described with respect to the first network node 120. After the process block 910, the flow 900 may transition to termination block 912.

At termination block 912, the flow 900 terminates. Alternatively, the flow 900 may be repeated periodically, in continuous fashion, or upon being triggered as a result of a condition, such as an impetus from the back-office system 108 indicating that the back-office system 108 is desirous of diagnosing and/or remediating one or more network nodes of the IB network 102.

In addition, any of the process blocks 604-910 may be repeated periodically, in continuous fashion, or upon being triggered as a result of a condition, without repeating the entire flow 900. For example, the process blocks 604-608 may be repeated a number of times before any of the process blocks 702 and 902-910 are carried out. Additionally and/or alternatively, any of (i) the process blocks 902, 906 and 908; (ii) the process blocks 702, 904, 906 and 908; (iii) the process blocks 906-908; (iv) the process block 906-910; (v) the process blocks 908-910; and (vi) the process block 910 may be repeated. This way, the back-office system 108 may repeatedly diagnose and/or remediate separately from the process blocks 604-608. Other combinations and permutations are possible as well.

Alternatively and/or additionally, the process blocks 902-910 may be carried out by the administrator node 106, instead of the back-office system 108. For example, at the process block 902, administrator node 106 obtains the network-node inventories 216₁₂₀, 216₁₂₂ and 216₁₂₄ from the access node 118 and/or the back-office system 108. To facilitate this, the admin software 516 may use its information-transfer module 518.

The information-transfer module 518 may, for example, obtain the network-node inventories 216₁₂₀, 216₁₂₂ and 216₁₂₄ by interfacing with and having the network-support-application interface 224₁₁₈ communicate such inventories 216₁₂₀, 216₁₂₂ and 216₁₂₄ to the administrator node 106 autonomously and/or via the synchronization routine. Alternatively, the information-transfer module 518 may request and receive the network-node inventories 216₁₂₀, 216₁₂₂ and 216₁₂₄ from any of (i) the network-support-application interface 224₁₁₈, (ii) the memory 204₁₁₈, and (iii) the back-office system 108.

As another alternative, the information-transfer module 518 may establish respective communications with the network-support-application interfaces 224₁₂₀, 224₁₂₂ and 224₁₂₄ or the memories 204₁₂₀ 204₁₂₂ and 204₁₂₄ of the first, second and third network nodes 120, 122 and 124. The information-transfer module 518 may establish such communications with the network-support-application interfaces 224₁₂₀, 224₁₂₂ and 224₁₂₄ or memories 204₁₂₀ 204₁₂₂ and 204₁₂₄ with or without interfacing with the network-support-application interface 224₁₁₈ of the access node 118. After establishing the communications, the information-transfer module 518 may interface with, request and receive the network-node inventories 216₁₂₀, 216₁₂₂ and 216₁₂₄ from the network-support-application interfaces 224₁₂₀, 224₁₂₂ and 224₁₂₄ or the memories 204₁₂₀ 204₁₂₂ and 204₁₂₄.

After the process block 902, the flow 900 may transition to the process block 906. As noted above, however, the flow 900 may transition from the process block 608 to the process block 702, instead of the process block 902. At the process block 702, the access node 118 aggregates the network-node inventories 216₁₂₀, 216₁₂₂ and 216₁₂₄ to form the aggregate information, as noted above with respect to flow 700 of FIG. 7. After the process block 702, the flow 700 may transition to the process block 904.

At the process block 904, the administrator node 106 obtains the aggregate information from the access node 118. To facilitate this, the admin software 516 may once again use its information-transfer module 418.

The information-transfer module 518 may, for example, obtain the aggregate information by interfacing with and having the network-support-application interface 224₁₁₈ communicate such aggregate information to the administrator node 106 autonomously and/or via the synchronization routine. Alternatively, the information-transfer module 518 may request and receive the aggregate information from the network-support-application interface 224₁₁₈ or the memory 204₁₁₈.

After obtaining the acquired information (i.e., any of the network-node inventories 216₁₂₀, 216₁₂₂ and 216₁₂₄ from the process block 902 and the aggregate information from the process block 904), the flow 900 may transition to the process block 906. At the process block 906, the administrator node 106 obtains the diagnostic information from the IB database 112. To facilitate this, the admin software 516 causes its diagnostic module 522 to query and obtain the diagnostic information from the IB database 112. The diagnostic module 522 may tailor its query and/or obtain the diagnostic information based on the acquired information (i.e., based on any of the network-node inventories 216₁₂₀, 216₁₂₂ and 216₁₂₄ from the process block 902 and the aggregate information from the process block 904). After obtaining the diagnostic information, the flow 900 may transition to the process block 908.

At the process block 908, the administrator node 106 evaluates the acquired content in accordance with the diagnostic information. To facilitate this, the admin software 516 causes its diagnostic module 522 to evaluate the acquired content in accordance with the diagnostic information to determine issues for remediation (“remediation issues”), if any.

After the process block 908, the flow 900 may transition to termination block 912 or, alternatively, to the optional process block 910. At the process block 910, the administrator node 106 performs remediation (e.g., enacts one or more corrective actions) for at least one of the first, second and third network nodes 120-124 in view of the remediation issues. For example, the administrator node 106 may perform remediation for the first network node 120 because the first network node 120 is not operating correctly and/or because the first network node 120 does not have one or more up-to-date network-node attributes (e.g., an old version of software).

To facilitate the remediation, the admin software 516 may establish a communication with the network-support-application interface 224₁₂₀. The admin software 516 generally does so using the access node 118 as a conduit. The admin software 516, however, may establish the communication with or without interfacing with the network-support-application interface 224₁₁₈ of the access node 118.

After establishing the communication, the diagnostic module 522 and/or information-transfer module 518 may interface with and/or provide (e.g., by pushing) the remediation information to the network-support-application interface 224₁₂₀ and/or the memories 204₁₂₀. The remediation information may be obtained from the back-office system 108.

Although not described in detail, the administrator node 106 may perform remediation for each of the second and third network nodes 122 and 124 in much the same way as described with respect to the first network node 120. After the process block 910, the flow 900 may transition to termination block 912.

At termination block 912, the flow 900 terminates. Alternatively, the flow 900 may be repeated periodically, in continuous fashion, or upon being triggered as a result of a condition, such as an impetus from the administrator node 106 indicating that the administrator node 106 is desirous of diagnosing and/or remediating one or more network nodes of the IB network 102.

As above, any of the process blocks 604-910 may be repeated periodically, in continuous fashion, or upon being triggered as a result of a condition, without repeating the entire flow 900. For example, the process blocks 604-608 may be repeated a number of times before any of the process blocks 702 and 902-910 are carried out. Additionally and/or alternatively, any of (i) the process blocks 902, 906 and 908; (ii) the process blocks 702, 904, 906 and 908; (iii) the process blocks 906-908; (iv) the process block 906-910; (v) the process blocks 908-910; and (vi) the process block 910 may be repeated. This way, the back-office system 108 may repeatedly diagnose and/or remediate separately from the process blocks 604-608. Other combinations and permutations are possible as well.

Although not shown in FIGS. 6-9, the back-office system 108 may issue the reports responsive to (i) obtaining the acquired information, (ii) performing the assessment of the IB network 102 and/or (iii) performing the diagnostic of the IB network 102. To facilitate this, the backend server 110 (via the reporting module 424 of the application server 401) may deliver, send or otherwise distribute the reports to interested parties via the WAN 104. The backend server 110 may, for example, send the reports via email. The reports may contain, for example, one or more security alerts correlated with the network-node inventories 216₁₂₀, 216₁₂₂ and 216₁₂₄, (e.g. network node 120 is a cause of a given security alert). The reports may also contain network-node inventories 216₁₂₀, 216₁₂₂ and 216₁₂₄, correlated with and contract reports (e.g. network nodes 120, 122 are covered by a given contract and have given service expiration dates.

While the foregoing is directed to embodiments of the present invention, other and further embodiments of the invention may be devised without departing from the basic scope thereof, and the scope thereof is determined by the claims that follow.

What is claimed is:

1. A method comprising:
performing, at an access node of a given network, network discovery to discover at least one node of the given network;
collecting, at the at least one node, an inventory of the at least one node;
collecting the inventory at the access node; and
sending the inventory from the access node to a back-office system external to the given network.

2. The method of claim 1, wherein the at least one node comprises first and second nodes, and wherein the inventory comprises an aggregation of: (i) first inventory information of the first node obtained at the first node, and (ii) second inventory information of the second node obtained at the second node.

3. The method of claim 1, wherein the at least one node comprises first and second nodes, and wherein collecting an inventory comprises:
collecting, at the first node, a first inventory of the first node; and
collecting, at the second node, a second inventory of the second node.

4. The method of claim 3, further comprising: aggregating, at the access node, the first and second inventory.

5. The method of claim 1, wherein the inventory comprises any of a device serial number, product identification, hardware and software information of the at least one node.

6. The method of claim 1, further comprising: sending to the at least one node from an administrator node external to the network in response to the inventory, information to manage the at least one node.

7. The method of claim 1, further comprising:
obtaining, from a database, install-base information associated with install base of the given network; and
correlating at least a portion of the inventory and the install-base information to establish a basis for the install base of the given network.

8. The method of claim 7, wherein the at least a portion of the inventory comprises information indicative of a current state of the install base, wherein the install-base information comprises information indicative of a contracted state, and wherein correlating at least a portion of the inventory information and the install-base information comprises:
correlating the information indicative of a current state with the information indicative of a contracted state.

9. A system comprising:
at least one node of a given network configured to collect its inventory; and
an access node of the given network configured to:
perform network discovery to discover the at least one node;
collect the inventory from the at least one node; and
send the inventory to a back-office system external to the network.

10. The system of claim 9, wherein the at least one node comprises first and second nodes, and wherein the inventory comprises an aggregation of: (i) a first inventory of the first node obtained at the first node, and (ii) a second inventory of the second node obtained at the second node.

11. The system of claim 9, wherein the at least one node comprises:
a first node configured to collect its first inventory; and
a second node configured to collect its second inventory.

12. The system of claim 11, wherein the access node is further configured to: aggregate the first and second inventories.

13. The system of claim 9, wherein the inventory comprises any of a device serial number, product identification, hardware and software information of the at least one node.

14. The system of claim 9, wherein the at least one node is further configured to:
receive, from an administrator node external to the given network, information to manage the at least one node.

15. The system of claim 9, further comprising:
a database comprising install-base information associated with the given network, and
a back-office system configured to correlating at least a portion of the inventory and the install-base information to establish a basis for an install base of the given network.

16. The system of claim 15, wherein the at least a portion of the inventory comprises information indicative of a current state of the install base, wherein the install-base information comprises information indicative of a contracted state, and wherein correlating at least a portion of the inventory information and the install-base information comprises:
correlating the information indicative of a current state with the information indicative of a contracted state.

17. An application stored on at least one computer-readable medium, the application comprising:
a first module having a first plurality of instructions that, when executed by a processor of at least one node of a network, cause the at least one node to collect an inventory of the at least one node; and
a second module having a second plurality of instructions that, when executed by a processor of at least one access node of a network, cause the access node to:
perform network discovery to discover the at least one node;
collect the inventory from the at least one node; and
send the inventory to a back-office system external to the network.

18. The application of claim 17, wherein the at least one node comprises first and second nodes, and wherein the inventory comprises an aggregation of: (i) a first inventory of the first node obtained at the first node, and (ii) a second inventory of the second node obtained at the second node.

19. The application of claim 17, wherein the at least one node comprises first and second nodes, and wherein the second plurality of instructions to cause at least one node to collect an inventory comprises:
instructions that, when executed by the processor of the first node, cause the first node to collect a first inventory of the first node; and
instructions that, when executed by the processor of the second node, cause the second node to collect a second inventory of the second node.

20. The application of claim 19, wherein the second module has a third plurality of instructions that, when executed by the processor of the access node, cause the access node to aggregate the first and second inventories.

21. The application of claim 17, wherein the inventory comprises any of a device serial number, product ID, hardware and software information of the at least one node.

22. The application of claim 17, further comprising a third module having a third plurality of instructions that, when executed by the processor of a device external to the network, cause the device to send to the at least one node, in response to the inventory, information to facilitate support of the at least one node.

23. The application of claim 17, further comprising a third module having a third plurality of instructions that, when executed by the processor of a device external to the network, cause the device to:
obtain, from a database, install-base information associated with install base of the given network; and
correlate at least a portion of the inventory and the install-base information to establish a basis for an install base of the given network.

24. The application of claim 23, wherein the at least a portion of the inventory comprises information indicative of a current state of the install base, wherein the install-base information comprises information indicative of a contracted state, and wherein the third plurality of instructions to cause the device to correlate at least a portion of the inventory and the install-base information comprises: instructions that, when executed by the processor of the device, cause the device to correlate the information indicative of a current state with the information indicative of a contracted state.
